(19) United States
(12) Patent Application Publication
(10) Pub. No.: US 2013/0307488 A1
(43) Pub. Date: Nov. 21, 2013

(54) BATTERY MANAGEMENT SYSTEM

(71) Applicant: Doosun Hwang, Yongin-si (KR)

(72) Inventor: Doosun Hwang, Yongin-si (KR)

(73) Assignee: Samsung SDI Co., Ltd., Yongin-si (KR)

(21) Appl. No.: 13/563,405

(22) Filed: Jul. 31, 2012

(30) Foreign Application Priority Data
May 15, 2012 (KR) 10-2012-0051569

(51) Int. Cl. H02J 7/00

(52) U.S. Cl. 320/161

(57) ABSTRACT

A battery management system is provided. In one embodiment, the battery management system includes a microcomputer unit that sets a charge amount of a battery to less than the total designed capacity of the battery and controls charging of the battery based on a constant current-constant voltage (CC-CV) charging method, and a current controller that controls an initial charge current applied to the battery according to the set charge amount.

### CROSS-REFERENCE TO RELATED APPLICATION

This application claims the benefit of Korean Patent Application No. 10-2012-0051569 filed on May 15, 2012, the contents of which are incorporated herein by reference in their entirety.

### BACKGROUND

1. Field

Aspects of the present invention relate to a battery management system.

2. Description of the Related Technology

A secondary battery is widely used for portable electronic devices, such as a cellular phone, a notebook computer, a camcorder or a personal digital assistant (PDA), or as a portable power supply for an appliance, such as a household vacuum cleaner or the like. There are various charging methods for achieving high speed charging or long cycle life of the secondary battery. Examples of the charging methods include a constant current-constant voltage (CC-CV) charging method, a boost charging method, a current attenuation charging method, a multistage CC-CV charging method, and a pulse charging method.

The CC-CV charging method is advantageous in view of low capacity reduction, fast charging time, convenient manipulation, long cycle life, and low internal resistance. The boost charging method is advantageous in view of high speed charging, so that a lithium ion battery can be charged to high current within a very short time. The current attenuation charging method is advantageous in that a charging time can be reduced using linearly decreasing current values, compared to the conventional CC-CV charging method, at the same depth of charge. The multistage CC-CV charging method is advantageous in that both high speed charging and cycle stability can be achieved. The pulse charging method is advantageous for high speed charging.

As described above, the charging methods aim to achieve either high speed charging or long cycle life. In a battery pack comprised of a plurality of secondary batteries connected in series/parallel, a cycle life of battery means a time required until customer's desired specification is fulfilled. Accordingly, an optimized charging method which takes into consideration a life degradation characteristic of a secondary battery is required.

### SUMMARY OF CERTAIN INVENTIVE ASPECTS

One embodiment may provide a battery management system having an improved life degradation characteristic of a secondary battery.

One embodiment may provide a battery management system including a microcomputer unit configured to set a charge amount of a battery to less than the total designed capacity of the battery and configured to control charging of the battery based on a constant current-constant voltage (CC-CV) charging method, and a current controller configured to control an initial charge current applied to the battery according to the set charge amount.

In some embodiments, the battery management system may further include a memory in which a characteristic table is stored, the characteristic table including charge amounts and initial charge current values depending on the state of health (SOH) of the battery.

In some embodiments, in the characteristic table, charge amount and initial charge current values gradually increase as the SOH of the battery is reduced to be in the range lower than lower than a predetermined level.

In some embodiments, the battery management system may further include an SOH estimation unit configured to estimate the SOH of the battery.

In some embodiments, the SOH estimation unit is configured to select the charge amount and initial charge current values from the characteristic table based on the estimated SOH.

In some embodiments, the SOH estimation unit may estimate the SOH using the following equation:

SOH[%]=(Current capacity of battery/Total designed capacity of battery)×100.

In some embodiments, the microcomputer unit may periodically receive the selected charge amount and initial charge current values and may set a charge amount of the battery.

In some embodiments, he current controller is configured to adjust the magnitude of the initial charge current applied to the battery using the received the initial charge current value.

In some embodiments, he battery management system may further include a voltage detector configured to detect a voltage of the battery and transmits the detected voltage to the microcomputer unit.

Additional aspects and/or advantages of the invention will be set forth in part in the description which follows and in part will be obvious from the description or may be learned by practice of the invention.

### BRIEF DESCRIPTION OF THE DRAWINGS

The above and other features will be more apparent from the following detailed description in conjunction with the accompanying drawings.

FIG. 1 illustrates a block diagram illustrating a configuration of a battery management system according to an embodiment of the present invention.

FIG. 2 illustrates a graph illustrating comparison results of charge amounts depending on battery degradation in the conventional CC-CV charging method and a charging method according to an embodiment of the present invention.

FIG. 3 illustrates a graph illustrating comparison results of initial charge currents depending on battery degradation in the conventional CC-CV charging method and a charging method according to an embodiment of the present invention.

FIG. 4 illustrates a graph illustrating comparison results of battery degradation characteristics in the conventional CC-CV charging method and a charging method according to an embodiment of the present invention.

### DETAILED DESCRIPTION

Exemplary embodiments now will be described more fully with reference to the accompanying drawings. The present disclosure may, however, be embodied in many different forms and should not be construed as being limited to the embodiments set forth herein.

In one embodiment, a configuration of a battery management system 100 will be described.

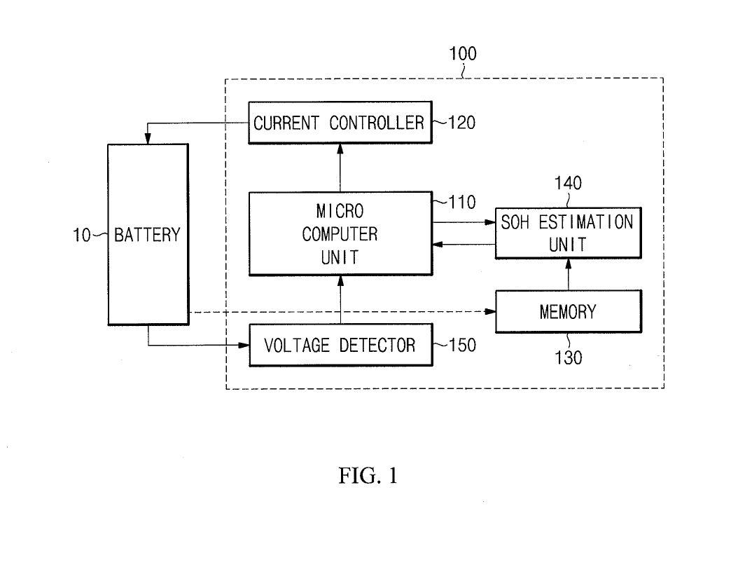

FIG. 1 illustrates a block diagram of a battery management system.

Referring to FIG. 1, the battery management system 100 includes a microcomputer unit 110, a current controller 120, a memory 130, a state of health (SOH) estimation unit 140, and a voltage detector 150.

The microcomputer unit 110 manages and controls the overall charge and discharge of a battery 10 based on a CC-CV method. In particular, the microcomputer unit 110 may control charging of the battery 10 in a state in which the charge amount of the battery 10 is set to less than less than the total design capacity of the battery 10. As used herein, total designed capacity means the electrical of battery 10 when the battery 10 is maximally charged. The term charge amount means an electrical capacity to be actually charged to the battery 10 during charging. In addition, the charge amount is referred to as the state of charging (SOC), as indicated in units of percent [%] based on the total designed capacity. For example, when the charge amount is expressed by “empty” and “full” states, “empty” may represent an SOC of 0% and “full” may represent an SOC of 100%, respectively. Here, the total designed capacity may also be represented in units of percent %.

As described above, the microcomputer unit 110 may set the charge amount of the battery 10 to less than the total designed capacity and may control the battery 10 to be charged to reach the charge amount. Here, as the life degradation of the battery 10 progresses, the charge amount set at the microcomputer unit 110 may gradually increase and may increase until the charge amount reaches the total designed capacity.

The microcomputer unit 110 may monitor the voltage and current of the battery 10 in a state in which the charge amount is set and may control the battery 10 to be charged to the set charge amount while controlling the operation of charge/discharge elements of the battery pack.

Meanwhile, the microcomputer unit 110 may periodically transmit a data request signal to the SOH estimation unit 140, may receive data from the SOH estimation unit 140 in response to the data request signal, and may control the current controller 120 according to the set charge amount, which will later be described in more detail.

The current controller 120 is electrically connected to the microcomputer unit 110 and controls an initial charge current applied to the battery 10 according to the charge amount set by the microcomputer unit 110. The term initial charge current may mean a charge current initially applied to the battery 10 for charging the battery 10 in the constant current charging method based on the CC-CV charging method, a current attenuation charging method, or a multistage CC-CV charging method. The current controller 120 may adjust the magnitude of the initial charge current flowing through the battery 10 when the battery 10 is charged to correspond to the initial charge current applied to the microcomputer unit 110.

A characteristic table, including charge amounts and initial charge current values of the battery 10 which depend on the state of health (SOH) of the battery 10, is pre-stored in the memory 130. The characteristic table is shown in Table 1. The data listed in Table 1 are provided only for illustration and may vary according to the specification of battery 10.

TABLE 1

| | A | | | B | | |
|---|---|---|---|---|---|---|
| | | | SOC1 | | | SOC2 |
| SOH[%] | T1[sec] | C1[C-rate] | [%] | T2[sec] | C2[C-rate] | [%] |
| 100~90 | 5566 | 0.50 C | 72.9% | 6095 | 1 C | 100% |
| 90~80 | 5327 | 0.51 C | 78.3% | 5566 | 1 C | 100% |
| 80~70 | 5145 | 0.52 C | 80.6% | 5327 | 1 C | 100% |
| 70~60 | 5001 | 0.53 C | 82.8% | 5145 | 1 C | 100% |
| 60~50 | 4863 | 0.54 C | 84.8% | 5001 | 1 C | 100% |
| 50~40 | 4744 | 0.56 C | 88.1% | 4863 | 1 C | 100% |
| 40~30 | 4635 | 0.57 C | 90.0% | 4744 | 1 C | 100% |
| 30~20 | 4533 | 0.59 C | 92.9% | 4635 | 1 C | 100% |
| 20~10 | 4432 | 0.61 C | 95.0% | 4533 | 1 C | 100% |
| 10~0 | 4337 | 0.64 C | 97.2% | 4432 | 1 C | 100% |

In Table 1, “A” represents charging data stored in the memory 130 according to an embodiment of the present disclosure. The charging data of the present embodiment is compared to “B” in Table 1, which represents charging data based on the conventional CC-CV method. In addition, SOH[%] represents life degradation of battery. In general, SOH[%] means the state of health of battery, which is used as the basis for indicating a reduction in the extent of the battery life or performance which occurs as the number of charge and discharge cycles increases and the battery is used for a prolonged period of time. Therefore, a decreasing SOH[%] may suggest that the battery life is gradually degrading. In Table 1, T1[sec] and T2[sec] represent charging time, C1[C-rate] and C2[C-rate] represent initial charge current values, and SOC1[%] and SOC2[%] represent charge amount values.

In the “A” data of Table 1, representing one embodiment of a charge method as described herein, the charge amount value SOC1[%] of battery may be a preset value under the user's desired specification in consideration of battery life degradation SOH[%], and the initial charge current value C1[C-rate] may be a value calculated in each increment of 10% reduction in a range from 100% to 0% based on the battery life degradation SOH[%].

In Table 1, referring to data based on the “A” method, in the characteristic table stored in the memory 130, whenever the SOH[%] of battery is reduced by 10% or less, the charge amount value SOC1[%] and the initial charge current value C1[C-rate] of battery periodically increase. On the other hand, referring to data based on the “B” method, that is, the conventional CC-CV method, the charge amount value SOC2[%] and the initial charge current value C2[C-rate] of battery are both maintained at constant values, irrespective of the SOH[%] of battery. In addition, as shown in Table 1, both of the initial charge current value C1 [C-rate] and charge amount value SOC1[%] based on the “A” method are set to be smaller than the initial charge current value C2[C-rate] and the charge amount value SOC2[%] based on the “B” method.

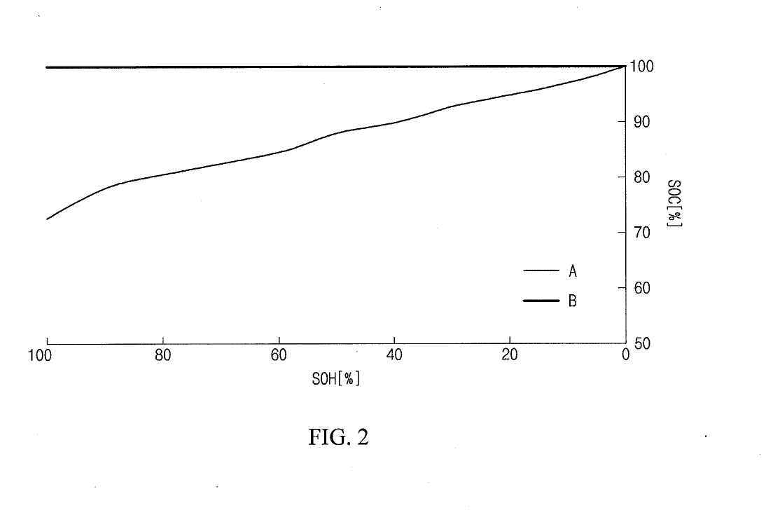

FIG. 2 illustrates a graph illustrating comparison results of charge amounts SOC [%] depending on battery degradation SOH [%] in the conventional CC-CV charging method (“B”) and a charging method (“A”) according to an embodiment of the present invention.

As shown in FIG. 2, in the charging method “A” according to the embodiment of the present invention, based on the characteristic table stored in the memory 130, as the battery life degradation represented by SOH[%] is progressed, the battery charge amount value SOC1[%] is gradually increased. On the other hand, in the conventional CC-CV charging method “B”, the battery charge amount value SOC2[%] is set to 100%, irrespective of the battery life degradation value SOH [%].

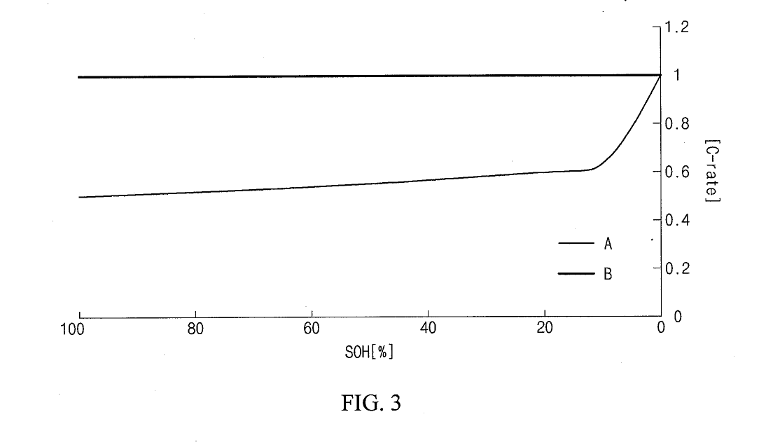

FIG. 3 illustrates a graph illustrating comparison results of initial charge current values C[C-rate] depending on battery degradation SOH [%] in the conventional CC-CV charging method (“B”) and a charging method (“A”) according to an embodiment of the present invention.

As shown in FIG. 3, in the charging method “A” according to an embodiment as described herein, as the battery life degradation represented by SOH[%] is progressed, the initial charge current value C1[C-rate] of a battery is gradually increased. On the other hand, in the conventional CC-CV charging method “B”, the initial charge current value C2[C-rate] of battery is set to a constant level, i.e., 100%, irrespective of the battery life degradation value SOH [%].

The SOH estimation unit 140 determines or estimates the SOH of the battery 10. The SOH estimation unit 140 may estimate the SOH of the battery 10 using the following equation:

SOH[%]=(Current capacity of battery/Total designed capacity of battery)×100 (1).

In addition, the SOH estimation unit 140 selects the charge amount value SOC1 [%] and the initial charge current value C1[C-rate] from the characteristic table based on the estimated SOH. For example, when the estimated SOH is 75%, the SOH estimation unit 140 may select 0.52 C and 80.6% from the characteristic table as the charge amount and initial charge current values, respectively.

Meanwhile, the microcomputer unit 110 may periodically transmit a data request signal to the SOH estimation unit 140 and may receive the data selected by the SOH estimation unit 140 in response to the received data request signal. Here, the microcomputer unit 110 receives the data for the charge amount value SOC1 [%] and the initial charge current value C1[C-rate] estimated by the SOH estimation unit 140. Thereafter, the microcomputer unit 110 may set the received charge amount value SOC1[%] as the charge amount value of the battery 10 and may control the current controller 120 by the received initial charge current value C1[C-rate]. Here, the current controller 120 may adjust the magnitude of the initial charge current applied to the battery 10 by the received initial charge current value C1[C-rate].

The voltage detector 150 is electrically connected to the battery 10 and detects a voltage of the battery 10 and transmits the detected voltage to the microcomputer unit 110. Here, the microcomputer unit 110 may manage and control charging and discharging of the battery 10 based on the received voltage data of the battery 10.

In some embodiments, the battery management system 100 operates as follows.

First, the microcomputer unit 110 identifies whether the battery 10 is in a charge mode or not, and if so, periodically transmits a data request signal to the SOH estimation unit 140. Here, as a method for identifying the charge mode, an electrical connection between an external device, such as a charger, and an external input terminal in the conventional battery pack, may be detected using the microcomputer unit 110, but aspects of the present invention are not limited thereto.

Next, the SOH estimation unit 140 receives the data request signal from the microcomputer unit 110 and estimates the SOH of the battery 10.

The SOH estimation unit 140 selects the charge amount and initial charge current values corresponding to the estimated SOH from the characteristic table stored in the memory 130 and transmits the selected data to the microcomputer unit 110 in response to the data request signal.

Next, the microcomputer unit 110 sets the charge amount value received from the SOH estimation unit 140 to the charge capacity required by the battery 10. In addition, the microcomputer unit 110 controls the current controller 120 by the initial charge current value received from the SOH estimation unit 140. Here, the current controller 120 may adjust the magnitude of the initial charge current initially applied to the battery 10 by the received initial charge current value.

Thereafter, charging of the battery 10 is carried out. Then, as degradation of the battery 10 progressed over the life of the battery, the charge amount and initial charge current values set by the battery management system 100 are periodically increased.

In general, when the SOH of the battery is high, there is a margin in the battery performance, and it is not necessary to charge the battery to the total designed capacity of 100%. Therefore, the initial charge rate is set to be lower than 100% and is then gradually increased to 100% as the battery life degradation is progressed with the passage of time, thereby effectively improving the battery life degradation characteristic. Here, whenever the current SOH of battery is reduced to be in the range lower than lower than a predetermined level, the initial charge current of battery may be gradually increased.

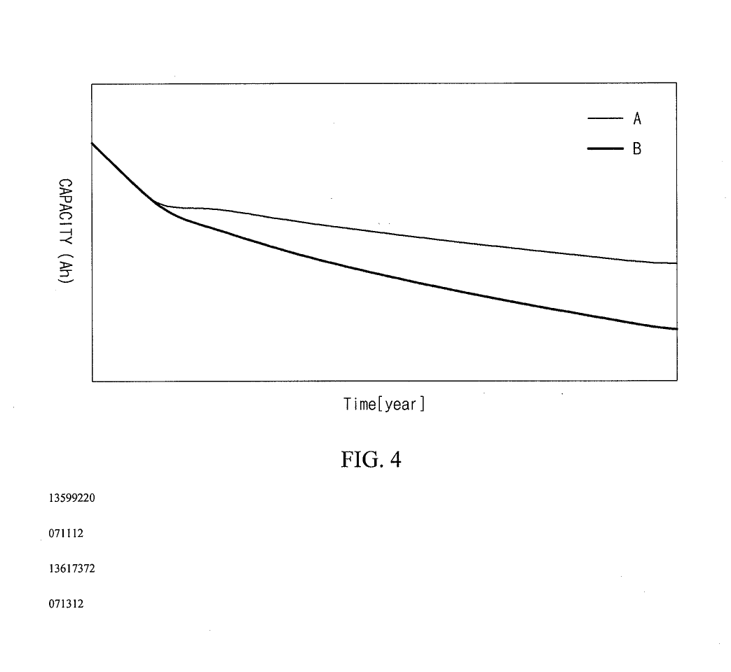

FIG. 4 illustrates a graph illustrating comparison results of battery degradation characteristics in the conventional CC-CV charging method (“B”) and a charging method (“A”) according to an embodiment of the present invention.

FIG. 4 illustrates the capacity of a battery (in Amp-hours) charged using the “A” method as described herein and the capacity of a battery charged using the “B” method. In a case where the battery is charged using the charging method “A” according to an embodiment as described herein, the life degradation characteristic of the battery is improved, compared to a case where the battery is charged using the conventional CC-CV charging method “B”.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A battery management system, comprising:
a microcomputer unit configured to set a charge amount of a battery to less than a total designed capacity of the battery and configured to control charging of the battery to have a first period based on at least a constant current (CC) charging method; and
a current controller configured to control an initial charge current applied to the battery according to the set charge amount.

2. The battery management system of claim 1, further comprising a memory in which a characteristic table is stored, the characteristic table including charge amounts and initial charge current values corresponding to a state of health (SOH) of the battery.

3. The battery management system of claim 2, wherein in the characteristic table, charge amount and initial charge current values gradually increase as the SOH of the battery is reduced to be in the range lower than lower than a predetermined level.

4. The battery management system of claim 2, further comprising an SOH estimation unit configured to estimate the SOH of the battery.

5. The battery management system of claim 4, wherein the SOH estimation unit is configured to select the charge amount and initial charge current values from the characteristic table based on the estimated SOH.

6. The battery management system of claim 4, wherein the SOH estimation unit is configured to estimate the SOH using the following equation:
SOH[%]=(Current capacity of battery/Total designed capacity of battery)×100.

7. The battery management system of claim 5, wherein the microcomputer unit periodically receives the selected charge amount and initial charge current values from the SOH estimation unit and sets a charge amount of the battery.

8. The battery management system of claim 7, wherein the current controller is configured to adjust the magnitude of the initial charge current applied to the battery based on the received initial charge current value.

9. The battery management system of claim 1, further comprising a voltage detector that detects a voltage of the battery and transmits the detected voltage to the microcomputer unit.
